(19) United States
(12) Patent Application Publication
(10) Pub. No.: US 2025/0354331 A1
(43) Pub. Date: Nov. 20, 2025

(54) HEAT TREATMENT OF TWISTED RIPCORDS TO IMPROVE ARMOR TEAR PERFORMANCE

(71) Applicant: CommScope Technologies LLC, Claremont, NC (US)

(72) Inventors: Eddy Houston, Claremont, NC (US); Jason N. Morrow, Taylorsville, NC (US)

(21) Appl. No.: 19/284,268

(22) Filed: Jul. 29, 2025

Related U.S. Application Data
(63) Continuation of application No. PCT/US2024/030125, filed on May 18, 2024.
(60) Provisional application No. 63/468,002, filed on May 21, 2023.

(51) Int. Cl. D07B 1/02; G02B 6/44

(52) U.S. Cl. CPC D07B 1/02; G02B 6/4431; D07B 2205/2039; D10B 2331/04

(57) ABSTRACT

A ripcord within a cable core is typically used to tear through an armor layer. The ripcord has its strength or ability to tear through the armor layer greatly improved by an applied heat treatment prior to being added to the cable core. The heat treatment homogenizes or normalizes the positioning of the fiber, yarn and strand twists within the ripcord, in a manner similar to an annealing process for metal or glass. The heat treatment may occur within an oven while the ripcord is loaded onto a spool. Alternatively, the heat treatment may occur in-line as the ripcord is being loaded onto the spool, or as the ripcord 10 is being fed from a spool into a cable manufacturing machine. The heat treatment is particularly well suited for polyester ripcords, which may be used to replace ripcords formed of aramid fibers.

This application is a continuation of International Application No. PCT/US2024/030125, filed May 18, 2024, which claims the benefit of U.S. Provisional Application No. 63/468,002, filed May 21, 2023, both of which are herein incorporated by reference.

### BACKGROUND OF THE INVENTION

### 1. Field of the Invention

The present invention relates to a ripcord for a cable, such as a communication, hybrid or power cable. More particularly, the present invention relates to a process of improving a strength, or more precisely a breakage resistance, of a twisted ripcord, such as polyester ripcord, so as to make it less likely that the ripcord breaks as it tears through an armor layer.

### 2. Description of the Related Art

Ripcords for communication cables, such as fiber optic cables, are generally known in the existing art and can be seen in U.S. Pat. Nos. 4,913,515; 5,029,974; 5,173,961; 5,268,983; 5,321,788; 5,542,020; 5,642,452; 5,621,841; 6,088,499; 6,563,991; 6,876,798 and 10,139,583 and US Published Application 2010/0129655, each of which is incorporated herein by reference.

The typical ripcord is formed by a plurality of textile fibers, such as several dozens of textile fibers, being twisted together in a first direction, e.g., clockwise, to form a yarn. Plural yarns are twisted together in a second direction, e.g., counterclockwise, to form a strand. Plural strands, typically three, are twisted together in the first direction, e.g., clockwise, to form the ripcord. General formulas and testing are used by the manufacturer to “balance” the twist lengths of the fibers to the opposite direction twist length of the yarn to create a balanced strand. Likewise, general formulas and testing are used by the manufacturer to “balance” the twist lengths of the yarns to the opposite direction twist length of the strand, so that the ripcord is basically stable and will not desire to untwist.

The textile fibers may be natural or synthetic. For ripcords in communication cables, the textile fibers are typically synthetic, and commonly formed of polyester, nylon or aramid fibers, e.g., Kevlar® fibers. Of the three common materials, ripcords formed by aramid fibers have the greatest tensile strength and are the most suitable for ripping through an armor layer of a communication cable. Aramid fiber ripcords are also the most expensive, when comparing ripcords of a same size, usually expressed in denier, which is a unit weight per length and a measure of fineness.

Polyester ripcords are cheaper than aramid ripcords but lack the tensile strength of an aramid ripcord and often break when attempting to tear through a metal armor layer of a communication cable. It is known to increase the diameter of the polyester ripcord, which relates to increasing the ripcord size in denier units. However, increasing the diameter of the ripcord adds cost and bulk to the communication cable, and may decrease flexibility. Often, a communication cable is designed to pass certain fire and smoke tests and adding the bulk of an increased diameter ripcord to the communication cable is detrimental, especially since it is common to include two ripcords spaced about one hundred eighty degrees apart beneath an armor layer.

### SUMMARY OF THE INVENTION

The Applicant has appreciated that it would be beneficial to use a ripcord to tear through an armor layer, wherein the ripcord is formed of a cheaper material than aramid fibers. The Applicant has experimented with existing ripcords formed of polyester to see if improvements could be made to the ripcords such that the ripcords are less likely to break when tearing through the armor layer of a communication cable. Through the experiments described hereinafter, the Applicant discovered processing steps which may be performed on ripcords currently on the market, which change the physical properties of the ripcord, such that it performs better when tearing through an armor layer of a cable.

These and other objectives are accomplished by a ripcord within a cable core, which is used to tear through an armor layer. The ripcord has its strength or ability to tear through the armor layer greatly improved by an applied heat treatment prior to being added to the cable core. The heat treatment homogenizes or normalizes the positioning of the fiber, yarn and strand twists within the ripcord, in a manner similar to an annealing process for metal or glass. The heat treatment may occur within an oven while the ripcord is loaded onto a spool. Alternatively, the heat treatment may occur in-line as the ripcord is being loaded onto the spool, or as the ripcord is being fed from a spool into a cable manufacturing machine. The heat treatment is particularly well suited for polyester ripcords, which may be used to replace ripcords formed of aramid fibers.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a front perspective view of a communication cable with first and second ripcords, in accordance with the present invention;

FIG. 2 is a perspective view of the armor layer of the cable of FIG. 1 showing an adherence of the first and second ripcords to an inner surface of the armor layer;

FIG. 3 is a closeup side view of a ripcord with the end slightly unraveled to show the construction of the ripcord;

FIG. 4 is a graph comparing the melt curves between thirty to two hundred ninety degrees Celsius for samples of ripcord, which were heat treated at sixty, eighty and one hundred degrees Celsius, as compared to a control sample of ripcord, which was not heat treated;

FIG. 5 is a graph focused on the melt curves between seventy to two hundred eighty-five degrees Celsius for samples of ripcord, which were heat treated at sixty, eighty and one hundred degrees Celsius, as compared to the control sample of ripcord, which was not heat treated;

FIG. 6 is a graph comparing the melt curves between seventy to two hundred eighty-five degrees Celsius for samples of ripcord, which were heat treated at one hundred, one hundred twenty-five and one hundred fifty degrees Celsius;

FIG. 7 shows a photograph of four samples of ripcord cut from a spool of ripcord which was subjected to a heat treatment at one hundred degrees Celsius for more than twenty-four hours, as compared to two samples of ripcord cut from a spool of ripcord which was not subjected to a heat treatment;

FIG. 8 shows a photograph of five samples of ripcord cut from a spool of ripcord which was subjected to a heat treatment at one hundred twenty-five degrees Celsius for more than twenty four hours, as compared to four samples of ripcord cut from a spool of ripcord which was subjected to a heat treatment at one hundred fifty degrees Celsius for more than twenty four hours;

FIG. 9 is a flowchart showing a first process for forming a ripcord;

FIG. 10 is a flowchart showing a second process for forming a ripcord; and

FIG. 11 is a flowchart showing a third process for forming a ripcord.

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

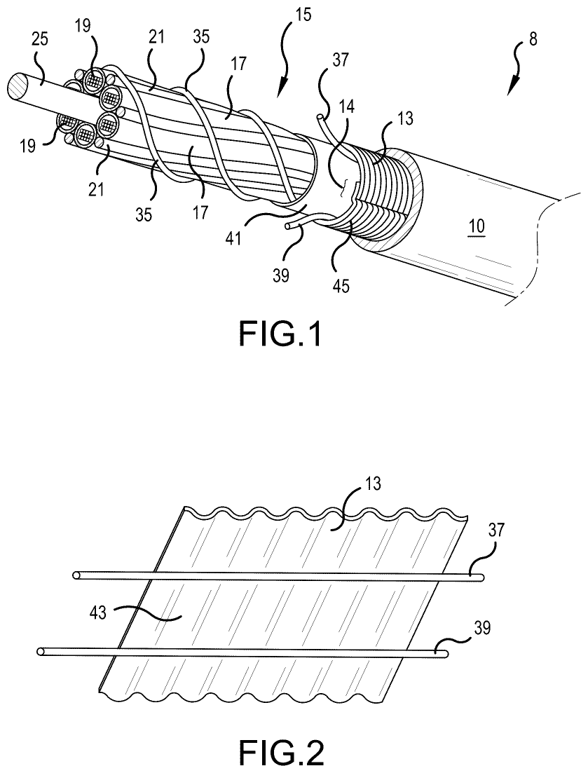

FIG. 1 shows a fiber optic communication cable 8, having many buffer tubes 17 and/or filler rods 21 bundled together, as is known in the prior art. The fiber optic cable 8 may have a six-around-one, eight-around-one or twelve-around-one configuration, wherein buffer tubes 17 and filler rods 21 are located around a central strength member 25. In FIG. 1, reference numeral 10 denotes an outer jacket. The outer jacket 10 surrounds an armor layer 13. The armor layer 13 surrounds a cable core 15 and has an overlapped portion 14.

In practice, the cable core 15 is made up of separate cabling elements including at least one communication element, such as one or more buffer tubes 17 with ribbon-connected or loose optical fibers 19 and/or one or more filler rods 21 and/or one or more insulated power conductors or twisted pairs. The strength member 25 may be formed as a fiber-reinforced plastic (FRP) rod, or more particularly a glass-reinforced plastic (GRP) rod. At least one binder 35 wraps around the cable core 15 to hold the cable core 15 together as the armor layer 13 and jacket 10 are applied. Commonly, first and second binders 35 form overlapping helixes which wrap around the cable core 15 in opposite directions. The binders 35 may be formed of a flat, synthetic polymer tape or round synthetic polymer thread. A wrap 41, such as a water blocking tape 41 may surround the cable core 15 and the at least one binder 35. Alternatively, the wrap 41 may be an elastic wrap or extrusion and may replace the at least one binder 35.

The armor layer 13, prior to being corrugated, is formed as a flat, elongated strip of material having a with W. Typical values for the width W are greater than 25 mm, such as 50 mm, 101 mm, 152 mm and 203 mm. The armor layer 13 arrives at the manufacturing factory on a spool or reel in a length exceeding 1,000 meters, such as 1,500 to 2,500 meters. During manufacturing, the armor layer 13 is corrugated before being wrapped around and surrounding the cable core 15. The corrugations increase the crush resistance of the armor layer 13. The armor layer 13 has the overlapped portion 14, which is preferably sealed. Sealing the armor layer 13 back onto itself at the overlapped portion 14 creates a moisture barrier in case a rodent, e.g., bird, squirrel or rat, chews through portions of the jacket 10, or in case the jacket 10 is slightly torn during installation.

First and second ripcords 37 and 39 are radially outward of the cable core 15 and radially inward of the armor layer 13. The ripcords 37 and 39 are provided for ripping the armor layer 13 when a sufficient manually pulling force is applied to one or both of the ripcords 37 and 39 by a technician. The technician typically uses the first and/or second ripcords 37 and 39 to access the cable core 15 during a midspan access or at an end of the cable 8 to perform a cable termination to a connector.

As shown in the perspective view of the corrugated armor layer 13 in FIG. 2, the first and second ripcords 37 and 39 may be adhered to a radially inward facing surface 43 of the armor layer 13. When the armor layer 13 extends completely around the cable core 15, the adherence of the first and second ripcords 37 and 39 places the first and second ripcords 37 and 39 about one hundred eighty degrees apart and places each of the first and second ripcords is 37 and 39 about ninety degrees away from the overlapped portion 14 of the armor layer 13. Lastly, the jacket 10 is extruded over a radially outward facing surface 45 of the armor layer 13.

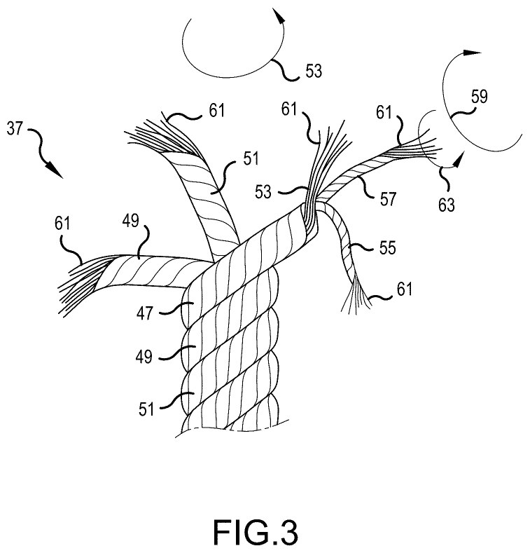

FIG. 3 is a closeup side view of an end of the first ripcord 37, noting that the first and second ripcords 37 and 39 may be identically constructed. In FIG. 3, the first ripcord 37 has its end slightly unraveled to show the construction of the first ripcord 37. The first ripcord 37 is formed from a plurality of strands, such as first, second and third strands 47, 49 and 51, twisted together in a first direction 53, such as counterclockwise. Each of the first, second and third strands 47, 49 and 51 is formed from a plurality of yarns, such as first, second and third yarns 53, 55 and 57, twisted together in a second direction 59, such as clockwise, opposite to the first direction 53. In FIG. 3, only the first strand 47 has its first, second and third yarns 53, 55 and 57 unraveled for illustration. The second and third strands 49 and 51 would also include three yarns each. Of course, a ripcord could include greater or fewer strands and greater or fewer yarns per strand.

Each of the first, second and third yarns 53, 55 and 57 is formed of a plurality, e.g., three to dozens, of textile fibers 61. The textile fibers 61 are twisted together in a third direction 63, such as counterclockwise, i.e., the same as the first direction 53. In the examples described herein, the textile fibers 61 are formed of a synthetic material, such as polyester. The diameter of the first ripcord 37 may be the same as the current commercially available ripcords, such as less than 0.1 inches, e.g., in the range of 0.01 to 0.05 inches.

As the origin of the present invention, the Applicant postulated that heat applied to a polyester ripcord during the cable manufacturing process might be weakening the polyester materials. In other words, the strength of a ripcord on a new spool from the ripcord manufacturer might have a greater tensile strength and cutting strength, i.e., an ability to tear though an armor layer, as compared to a ripcord which had been fed through a cable manufacturing machine and subjected to heat during extrusion of the jacket 10 over the armor layer 13 of the communication cable 8.

The jacket's temperature is about 225 degrees Celsius during extrusion and this temperature is dissipated as the cable is passed through a water bath. It was believed that the armor layer beneath the jacket would shield the ripcord from most of the heat. However, it was suspected that some of the jacket's heat would be transferred through the armor layer to the ripcord and might be deteriorating the strength of a polyester ripcord.

To test the theory, new spools of ripcord from the ripcord manufacturer were tested under various heating scenarios. A first sample was subjected to an oven at 60 degrees Celsius until the entirety of the ripcord reached 60 degrees Celsius. With only a few feet of ripcord in an oven this would be achieved in a few minutes. If an entire spool of ripcord, e.g., 25 to 30 thousand feet of ripcord were heat treated, the cook time would need to be extended to 24 to 48 hours just to be certain that the entirety of the ripcord on the spool reached the desired temperature.

Second, third, fourth and fifth samples were likewise prepared in oven temperatures of 80, 100, 125 and 150 degrees Celsius, respectively. The first through fifth samples were allowed to cool to room temperature and were then measured and tested to see if the physical attributes and the performance of the polyester ripcord had been affected by the heat treatment. The following table summarizes some of the findings relating to the five different heat treated samples of ripcord as compared to a control sample of ripcord, where the control sample of ripcord had not been subjected to a heat treatment:

| | | | Max | Elongation | | | |
|---|---|---|---|---|---|---|---|
| | | Diameter | Load | (% @ | Melt | Area | Delta |
| | | (inches) | (Lbs) | Break) | Point ° C. | (mJ) | H (J/g) |
| Control | | 0.0434 | 95.1 | 93.0 | 254.7 | 444.3 | 41.0 |
| 60 | C. | 0.0438 | 95.1 | 91.0 | 253.6 | 575.8 | 43.4 |
| 80 | C. | 0.0436 | 96.8 | 89.0 | 255.0 | 844.3 | 42.8 |
| 100 | C. | 0.0431 | 95.6 | 93.0 | 255.3 | 919.9 | 41.1 |
| 125 | C. | 0.04352 | 94.9 | 97.0 | 255.4 | 848.0 | 42.0 |
| 150 | C. | 0.04293 | 93.2 | 93.2 | 255.7 | 805.0 | 45.0 |

As shown in the table above, it was observed that the physical appearance, such as the diameter of the five samples had no significant change, e.g., about 1% or less, from the control sample. The primary purpose of the heat treatments was to see if the tensile strength changed. The tensile strength, e.g., max load, at which the five heat-treated samples broke did not significantly decline due to the application of heat, as had been suspected. Rather, the lower levels of heat application of the second and third samples caused the tensile strength to increase by about 1 to 2%, while the higher heat application of the fourth and fifth samples caused the tensile strength to decrease by about 1 to 2%.

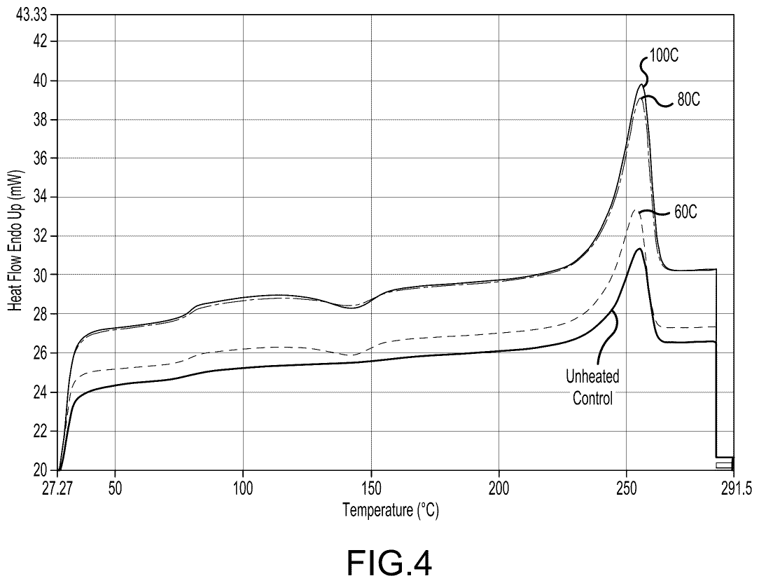

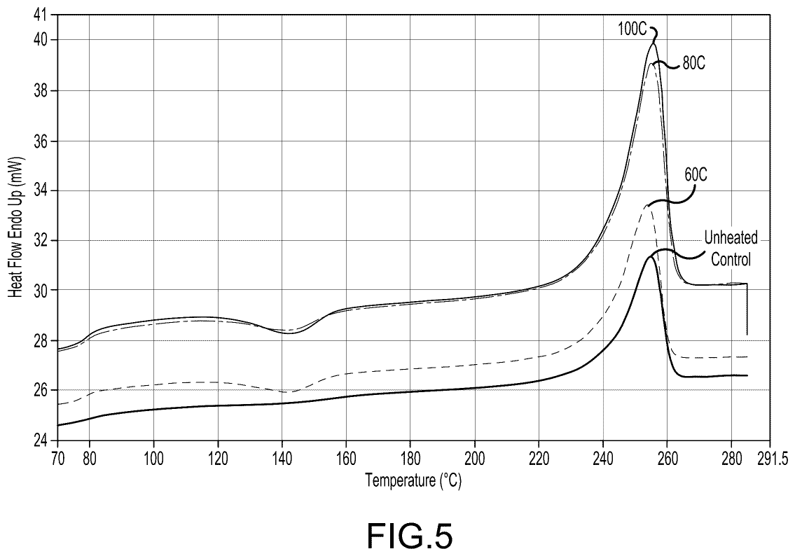

FIGS. 4-6 are graphs showing the amount of heat absorbed by the control sample ripcord and the first, second and third heat-treated samples as the ripcords were heated through a given temperature range. In the graphs of FIGS. 4-6 the Y axis represents “Heat Flow Endo Up (mW),” while the X axis represents temperature in Celsius. FIG. 4 is a graph comparing the melt curves between thirty to two hundred ninety degrees Celsius for samples of ripcord, which were heat treated at sixty, eighty and one hundred degrees Celsius, as compared to a control sample of ripcord, which was not heat treated. FIG. 5 is a graph showing the same data, but focuses on the melt curves between seventy to two hundred eighty-five degrees Celsius for samples of ripcord, which were heat treated at sixty, eighty and one hundred degrees Celsius, as compared to a control sample of ripcord, which was not heat treated.

For the testing shown in FIGS. 4 and 5, the first, second and third test samples, which were previously heated to sixty, eighty and one hundred degrees Celsius for about forty-eight hours, were allowed to fully cool to room temperature. The first, second and third samples, along with a control sample of ripcord which did not receive a heat treatment and was also at room temperature, were placed into a heat testing device. The graph lines illustrate an amount of heat energy which was absorbed by the test samples and the control sample to a point of melting. It is interesting to note that the third test sample was able to absorb more heat energy, e.g., the area under the graph line, as compared to the control sample and the first and second test samples.

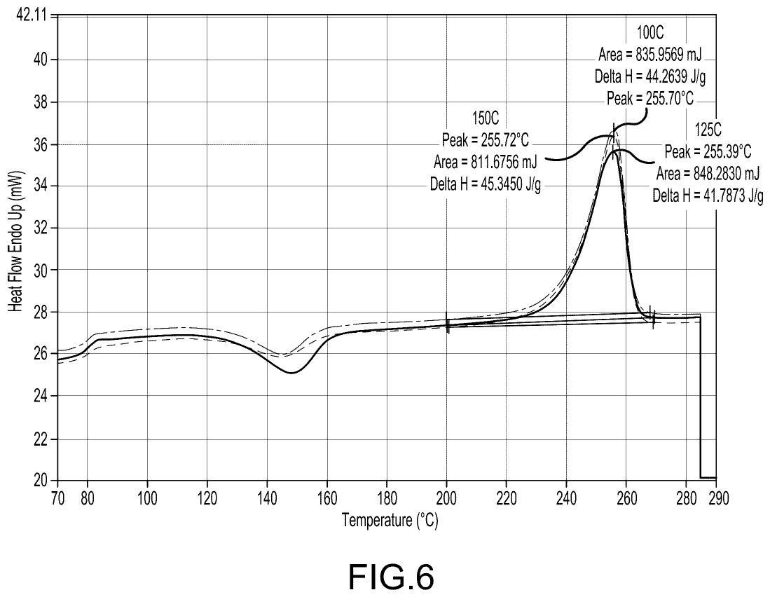

For the testing shown in FIG. 6, the third, fourth and fifth test samples, which were previously heated to one hundred, one hundred twenty-five and one hundred fifty degrees Celsius for about forty-eight hours, were allowed to fully cool to room temperature. The third, fourth and fifth samples were placed into the same heat testing device. The graph lines illustrate an amount of heat energy which was absorbed by the test samples to a point of melting. It is interesting to note that again the third test sample was able to absorb more heat energy, e.g., the area under the graph line, as compared to the fourth and fifth test samples.

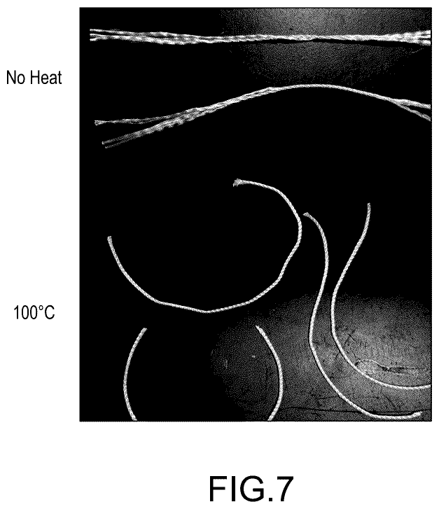

The Applicant noted that a material change to the ripcord seems to be optimized within a temperature range of about 100 degrees Celsius, for example in the range of 80 to 120 degrees Celsius, more likely in the range of 85 to 110 degrees Celsius, or about 90 to 105 degrees Celsius. Four-inch-long pieces of the control sample ripcord and the first through fifth heat-treated samples of ripcord were prepared and an unusual structural change was observed. As seen in the photo of FIG. 7, the two four-inch pieces of the control sample of ripcord had a natural tendency to unravel. In fact, about 70% of the four-inch-long control sample of ripcord unraveled to expose the three strands of the ripcord. Further, each strand of the ripcord unraveled to expose up to 10% of the yarns of the strands.

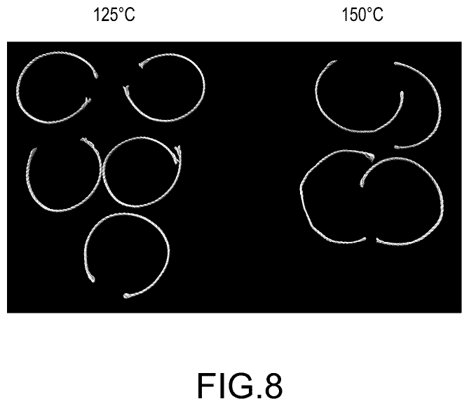

FIG. 7 also shows four pieces of the third sample of ripcord cut at a length of about four inches. Of note is that the third sample did not unravel to the same extent. In fact, less than 5% of the four-inch-long third sample of ripcord unraveled to expose the three strands of the ripcord, and the strands showed little, e.g., 5% or less, of unraveling to expose the yarns of the strand. FIG. 8 shows that four-inch pieces of the fourth and fifth ripcord samples also did not unravel to the same extent as the control sample of ripcord. Out of curiosity, a piece of ripcord from a manufactured cable was removed from the cable and cut into four-inch pieces to see if the ripcord's exposure to heat during the cable manufacturing process affected the ripcord in a way similar to a heat treatment. It was found that the ripcord from a cable actually preformed similarly to the control sample of ripcord and showed a similar, high degree of unraveling when cut.

Based upon the physical observations, it is believed that the heat treatment provided to the ripcord takes the resiliency or memory out of the fibers. In other words, the heat fixes the molecules in a final twisted state so they don't have a tendency to relax back to a previous untwisted state, i.e., unravel. The heat treatment seems to induce a permanent structural change similar to the annealing process for metals, glass and ceramics.

It is noted that the glass transition state for polyester starts at about 68 degrees Celsius and continues up to the melting point of polyester which is about 295 degrees Celsius. Based upon experimental results and the observations concerning the ability of different heat treated samples to absorb heat energy, it is believed that the optimum temperature to heat a polyester ripcord is within the lower levels of the glass transition range. A heat treatment in the higher ranges of the glass transition range may weaken the ripcord. For example, a heat treatment in the range of 80 to 120 degrees Celsius, more likely in the range of 85 to 110 degrees Celsius, or about 90 to 105 degrees Celsius, seems well suited to stabilizing the twists within the ripcord so that a cut ripcord will not tend to unravel. Once all parts of the ripcord are elevated to the predetermined temperature, it may be beneficial to hold the temperature for a predetermined period of time, e.g., an hour or so in the case of an oven heating of a spool of ripcord, to ensure that transition occurs throughout the layers of ripcord on the spool. If the heating is done as an in-line process, during spooling or unspooling of the ripcord, a slightly higher heat may be employed. Also, it is believed that the vibration of the ripcord during the inline processing will assist in the transitioning of the fibers of the ripcord. To this end, the trays in the oven may be made to vibrate the spools to speed the transitioning during the heat treatment.

The transition of the fibers of the ripcord might also be referred to as a homogenizing or normalizing process of the fibers within the ripcord. The transition would remove internal stresses within the ripcord and make the ripcord less likely to unravel when cut. The Applicant has noted that a main reason why polyester ripcords are weak and break when being pulled through a metal armor layer is because when one strand breaks along an edge of the metal armor, it quickly unravels from the remaining strands and pulls away from the remaining strands bearing against the edge of the armor layer. As such, a ripcord with three strands will immediately only have two thirds of the strength to tear through the metal armor layer because the cut strand unraveled and left the area of the ripcord in contact with the metal armor layer.

This also applies to the yarns forming each strand. If a cut yard quickly unravels and pulls away from its strand far from the edge of the metal armor layer being pulled through by the ripcord, the strand is severely weakened and much more likely to break, which will lead to the breakage of the ripcord. With the heat treatment, the ripcord tends to hold together and not unravel. Hence, a broken yarn of a strand will remain close to the ripcord at the break, and as it passes the tear point, the ripcord will remain intact as portions of the ripcord downstream come into contact with new edges of the metal armor layer as the ripcord continues tearing through the armor layer. By this operation, downstream ripcord sections being pulled through the armor layer remain strong and the cascading effect of an unraveling ripcord and its consequential weakening of the ripcord will be avoided.

As mentioned previously, a ripcord sample removed from a cable still unravels when cut. The heat of the extruded jacket is insufficient to cause the transition process to homogenize or normalize the twisted fibers of the ripcord. The metal armor layer initially shields the ripcord from the heat of the jacket extrusion and the speed of the cable manufacturing process, e.g., 200 meters per minute, dissipates the jacket heat quickly within the cooling water bath. Hence, the Applicant has invented several processes to provide a heat treatment to a ripcord prior to the ripcord being placed within the metal armor layer.

A common theme of the processes is that the ripcord undergoes a heat treatment prior to being disposed within the communication cable, wherein the heat treatment includes heating the ripcord to a predefined temperature for a predetermined period of time, and wherein a combination of the predefined temperature and the predetermined period of time ensures that all portions of the interior and exterior of the ripcord reach at least 70 degrees Celsius, more preferably at least 80 degrees Celsius, and in a most preferred embodiment at least 90 degrees Celsius.

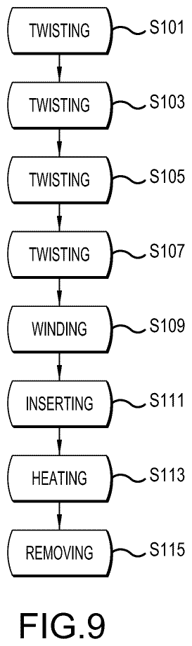

FIG. 9 shows a first process for forming the ripcord 37. The first process includes twisting (S101) a plurality of first textile yarns 61 together to form a first strand 47. Twisting (S103) a plurality of second textile yarns 61 together to form a second strand 49. Twisting (S105) a plurality of third textile yarns 61 together to form a third strand 51, and twisting (S107) the first, second and third strands 47, 49 and 51 together to form a ripcord 37. In a preferred embodiment, the direction of the twisting (S101, S103 and S105) is in a first direction and the direction of the twisting (S107) is in a second, opposite direction.

Next in the second process for forming the ripcord, winding (S109) the ripcord 37 onto a spool. Inserting (S111) the spool with the ripcord thereon into an oven, and heating (S113) the ripcord within the oven to a predefined temperature for a predetermined period of time, wherein a combination of the predefined temperature and the predetermined period of time ensures that all portions of the interior and exterior of the ripcord reach at least 70 degrees Celsius. In a preferred embodiment, the predetermined temperature is at least 90 degrees Celsius, and the predetermined period of time exceeds at least twelve hours. Finally, removing (S115) the reel from the oven and allowing it to cool for later normal processing as a ripcord in the manufacturing of a cable.

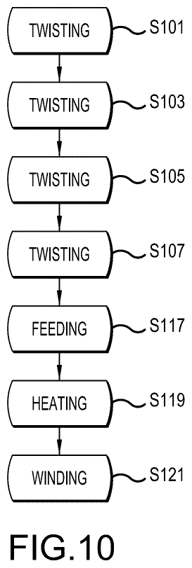

FIG. 10 shows a second process for forming the ripcord 37. The second process includes twisting (S101) a plurality of first textile yarns 61 together to form a first strand 47. Twisting (S103) a plurality of second textile yarns 61 together to form a second strand 49. Twisting (S105) a plurality of third textile yarns 61 together to form a third strand 51, and twisting (S107) the first, second and third strands 47, 49 and 51 together to form a ripcord 37. In a preferred embodiment, the direction of the twisting (S101, S103 and S105) is in a first direction and the direction of the twisting (S107) is in a second, opposite direction.

Next in the second process for forming the ripcord 37, feeding (S117) the ripcord 37 into a heating section and heating (S119) the ripcord 37 within the heating section to a predefined temperature for a predetermined period of time, wherein a combination of the predefined temperature and the predetermined period of time ensures that all portions of the interior and exterior of the ripcord 37 reach at least 70 degrees Celsius. Then, winding (S121) the ripcord 37 onto a spool, whereby the heating (S119) the ripcord 37 occurs within the heating section as an in-line process during the winding (S121) of the ripcord 37 onto the spool.

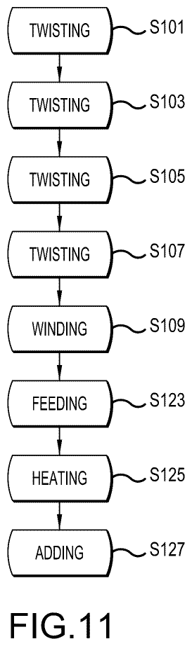

FIG. 11 shows a third process for forming the ripcord 37. The third process includes twisting (S101) a plurality of first textile yarns 61 together to form a first strand 47. Twisting (S103) a plurality of second textile yarns 61 together to form a second strand 49. Twisting (S105) a plurality of third textile yarns 61 together to form a third strand 51, and twisting (S107) the first, second and third strands 47, 49 and 51 together to form a ripcord 37. In a preferred embodiment, the direction of the twisting (S101, S103 and S105) is in a first direction and the direction of the twisting (S107) is in a second, opposite direction.

Next in the third process for forming the ripcord 37, winding (S109) the ripcord 37 onto a spool, which is shipped to a cable manufacturing facility and mounting to a communication cable manufacturing machine. Feeding (S123) the ripcord 37 into a heating section of the communication cable manufacturing machine, and heating (S125) the ripcord 37 within the heating section to a predefined temperature for a predetermined period of time, wherein a combination of the predefined temperature and the predetermined period of time ensures that all portions of the interior and exterior of the ripcord 37 reach at least 70 degrees Celsius. Lastly, adding (S127) the ripcord 37 into or onto a cable core, whereby the heating (S125) the ripcord 37 occurs within the heating section as an in-line process during the cable manufacturing process.

In the in-line heating (S119 and S125) processes the ripcord 37 may be passed through an area heated by flame or an electrically powered resistive element, by passing the ripcord 37 through a laser heat treatment, by passing the ripcord 37 through a hot air stream, and/or by passing the ripcord 37 through a heated liquid bath, or by other known methods of heating an object, e.g., microwaving.

In the embodiments described herein the textile fibers, yarns and strands are formed of synthetic materials other than aramid fibers, such as polyester. Although polyester has been described in the preferred embodiment of the present invention, it is believed that other fibers may benefit from the heat treatments described herein. For example, ripcords formed of natural and/or synthetic fiber selected from the group consisting of polyester, polyethylene, nylon, polypropylene, fiberglass, PBO (poly(p-phenylene-2,6-benzobisoxazole), branded Zylon®), PBI (Polybenzimidazole), and aramid may be heat treated and potentially produce a ripcord with an improved tear performance. It is also known to mix fibers of various materials when forming a ripcord, and ripcords with such mixed materials may be heat treated and potentially produce a ripcord with an improved tear performance.

In one embodiment, the heat-treated ripcord may have a coating applied thereto. It is preferred that that the coating is applied over the ripcord 37 after the heating (S113, S119 and S125) of the ripcord 37. Although if the coating is immune to the heating (S113, S119 and S125), then the coating may be applied prior to the heating (S113, S119 and S125) of the ripcord 37. The coating may be hygroscopic and may include superabsorbent polymer (SAP) materials.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A ripcord for a cable formed by the process of:
twisting a plurality of first textile yarns together to form a first strand;
twisting a plurality of second textile yarns together to form a second strand;
twisting the first and second strands together to form said ripcord; and
heating said ripcord to a predefined temperature for a predetermined period of time, wherein a combination of the predefined temperature and the predetermined period of time ensures that all portions of the interior and exterior of said ripcord reach at least 70 degrees Celsius.

2. The ripcord according to claim 1, wherein said first and second textile yarns are formed of polyester.

3. The ripcord according to claim 1, wherein said first and second textile yarns are formed of synthetic fibers other than aramid fibers.

4. The ripcord according to claim 1, wherein the predetermined temperature is at least 90 degrees Celsius.

5. The ripcord according to claim 4, wherein the predetermined period of time exceeds at least twelve hours.

6. The ripcord according to claim 1, wherein the process further comprises:
twisting a plurality of third textile yarns together to form a third strand, and wherein the twisting the first and second strands together includes also twisting the third strand along with the first and second strands to form said ripcord.

7. The ripcord according to claim 6, wherein said first, second and third textile yarns are formed of polyester.

8. The ripcord according to claim 1, wherein the process further comprises:
applying a coating over said ripcord and wherein said coating is a hygroscopic coating or includes SAP materials.

9. A communication cable comprising:
a cable core including at least one communication element;
an armor layer surrounding said cable core; and
a ripcord being disposed radially inward of said armor layer for ripping said armor layer when a sufficient pulling force is applied to said ripcord, wherein said ripcord is formed by the process of:
twisting a plurality of first textile yarns together to form a first strand;
twisting a plurality of second textile yarns together to form a second strand;
twisting the first and second strands together to form said ripcord; and
heating said ripcord to a predefined temperature for a predetermined period of time, wherein a combination of the predefined temperature and the predetermined period of time ensures that all portions of the interior and exterior of said ripcord reach at least 70 degrees Celsius.

10. The communication cable according to claim 9, wherein said ripcord is a first ripcord and further comprising:
a second ripcord formed by the process of:
twisting a plurality of first textile yarns together to form a first strand;
twisting a plurality of second textile yarns together to form a second strand;
twisting the first and second strands together to form said ripcord; and
heating said ripcord to a predefined temperature for a predetermined period of time, wherein a combination of the predefined temperature and the predetermined period of time ensures that all portions of the interior and exterior of said ripcord reach at least 70 degrees Celsius; and
wherein said armor layer extends completely around said cable core and overlaps onto itself at an overlapped portion, and wherein said first and second ripcords are adhered to a radially inward facing surface of said armor layer at positions which are about one hundred eighty degrees apart when said armor layer extends completely around said cable core, and wherein each of said first and second ripcords is located about ninety degrees away from said overlapped portion of said armor layer when said armor layer extends completely around said cable core.

11. The communication cable according to claim 9, wherein said armor layer is corrugated.

12. A method of forming a ripcord for a cable comprising:
twisting a plurality of first textile yarns together to form a first strand;
twisting a plurality of second textile yarns together to form a second strand;
twisting the first and second strands together to form the ripcord; and
heating the ripcord to a predefined temperature for a predetermined period of time, wherein a combination of the predefined temperature and the predetermined period of time ensures that all portions of the interior and exterior of the ripcord reach at least 70 degrees Celsius.

13. The method according to claim 12, wherein the process further comprises:
winding the ripcord onto a spool.

14. The method according to claim 13, wherein the process further comprises:
mounting the spool to a communication cable manufacturing machine; and
feeding the ripcord into a heating section of the communication cable manufacturing machine, and wherein the heating the ripcord occurs within the heating section of the communication cable manufacturing machine as an in-line process during the manufacturing of a communication cable.

15. The method according to claim 14, wherein the feeding the ripcord into a heating section of the communication cable manufacturing machine includes at least one of:
passing the ripcord through an area heated by flame or an electrically powered element,
passing the ripcord through a laser heat treatment,
passing the ripcord through a hot air stream; and
passing the ripcord through a heated liquid bath.

16. The method according to claim 13, wherein the process further comprises:
inserting the spool with the ripcord thereon into an oven, and wherein the heating the ripcord occurs within the oven.

17. The method according to claim 13, wherein the process further comprises:
feeding the ripcord into a heating section prior to the winding the ripcord onto the spool, whereby the heating the ripcord occurs within the heating section as an in-line process during the winding the ripcord onto the spool.

18. The method according to claim 12, wherein the predetermined temperature is at least 90 degrees Celsius.

19. The method according to claim 18, wherein the predetermined period of time exceeds at least twelve hours.

20. The method according to claim 12, wherein the process further comprises:
applying a coating over said ripcord and wherein said coating is a hygroscopic coating or includes SAP materials.
